(19) United States
(12) Patent Application Publication
(10) Pub. No.: US 2011/0120420 A1
(43) Pub. Date: May 26, 2011

(54) Method for determining a characteristics map of the injection quantity via an electric variable of an electrically triggered fuel injector

(75) Inventor: Metin Gencbay, Bursa (TR)

(73) Assignee: ROBERT BOSCH GMBH, Stuttgart (DE)

(21) Appl. No.: 12/308,493

(22) PCT Filed: Sep. 25, 2007
(86) PCT No.: PCT/EP2007/060138

§ 371 Date: Aug. 9, 2010

(30) Foreign Application Priority Data
Oct. 25, 2006 (DE) 10 2006 050 171.3

(51) Int. Cl. F02M 51/00

(52) U.S. Cl. 123/478

(57) ABSTRACT

A method for determining a characteristics map of the injection quantity (Q) via an electric variable (U_{B}) of an electrically triggered fuel injector. The electric variable (U_{B}) is varied during operation of the internal combustion engine, from an initial value (U0) at which no injection is delivered, until a defined first injection quantity (Q₁) is injected, the value (U₁) set at the defined first injection quantity being assigned to the defined first injection quantity (Q₁) as first value (U₁) of the electric variable (U_{B}).

### BACKGROUND INFORMATION

The present invention relates to a method for determining a characteristics map of the injection quantity via an electrical variable of an electrically triggered fuel injector.

Electrically triggered fuel injectors, which are used in connection with what is referred to as common rail injection systems, are known from the related art. Such fuel injectors are usually provided with a piezoelectric actuator, which can move a valve needle via an hydraulic coupler element. The piezo actuator is situated directly above the needle and surrounded by fuel that is under high pressure. Due to long-term drift (ageing and the like) of the electric and mechanical properties of the injector, it may happen in an ageing fuel injector that the pre-injection or, in general, an injection of small quantities fails to take place or is delivered in different quantities, since the values applied for a new injector, such as a bottom voltage and trigger period, for example, no longer suffice to open the aged (drifted) injectors, or that the drift results in an incorrect injection quantity. This leads to increased combustion noise, which may be annoying especially during idling. An increase in the pre-injection quantity due to drift of the injector may also have a detrimental effect on the exhaust-gas composition.

### DISCLOSURE OF THE INVENTION

Therefore, one of the objects of the present invention is to detect and correct deviations of a fuel injector from the setpoint state caused by ageing or long-term drift.

This problem is solved by a method for determining a characteristics map of the injected fuel quantity via an electric variable of an electrically triggered injector, the electric variable being varied during operation of the internal combustion engine, from an initial value at which no injection is delivered, until a defined first injection quantity is delivered, the value set at the defined first injected fuel quantity being assigned to the defined injected fuel quantity as first value of the electric variable. The method is preferably carried out during a pre-injection. The associated main injection is implemented in unchanged form, the injected fuel quantity rising as soon as the pre-injection has been delivered successfully. This ensures that the combustion takes place but the torque contribution is lower than with an implemented pre-injection. It can therefore be monitored whether the pre-injection was delivered by determining the torque contribution toward the overall torque of the internal combustion engine for the particular monitored injection. Preferably, the method is implemented during overrun operation of the internal combustion engine since the torque contribution missing in those case without pre-injection has only a negligible effect on the driving comfort of a motor vehicle driven by the internal combustion engine. The electric variable is preferably modified in a further method step in such a way that a defined second injection quantity is injected, the value set at the defined second injection quantity being assigned to the defined second injection quantity as second value of the electric variable. Thus, two value pairs voltage range/injection quantity are determined. From the value pair of the first injection quantity having the first electric value, as well as the value pair of the second injection quantity and the second electric value, a characteristics map of electrical value to injection quantity is preferably determined by an extrapolation and interpolation function. In addition, further value pairs may be included in the extrapolation or interpolation, so that the accuracy of the formed extrapolation or interpolation function is able to be improved. The extrapolation and interpolation function preferably is a linear function. The electrically triggered fuel injector is preferably triggered piezoelectrically, the electric variable being the voltage range between a holding voltage and a bottom voltage. To determine a characteristics map of the injection quantity over the voltage range of the piezoelectric injector, the voltage range is increased during operation of the combustion engine, from an initial voltage range at which no injection is delivered, until a defined injection quantity is injected, the voltage range set at the defined injection quantity being assigned to the defined injection quantity.

The actually injected fuel quantity is preferably determined on the basis of the time characteristic of the torque of the crankshaft of the internal combustion engine. In this context, the injection quantity is preferably determined with the aid of an overrun gas torque model of a cylinder of the internal combustion engine, from the time characteristic of the torque of the crankshaft of the internal combustion engine.

The problem mentioned in the introduction is also solved by a device, in particular an internal combustion engine or control device for an internal combustion engine, which is designed to determine a characteristics map of the injection quantity via an electric variable of an electrically triggered injector, the electric variable being varied during operation of the internal combustion engine, from an initial value at which no injection is delivered, until a defined first injection quantity is delivered, the value set at the defined first injection quantity being assigned to the defined injection quantity as first value of the electric variable. The objective indicated at the outset is also achieved by a computer program having program code for carrying out all of the steps according to a method of the present invention when the program is executed on a computer.

An exemplary embodiment of the present invention is explained in detail in the following text with reference to the accompanying drawing.

The figures show:

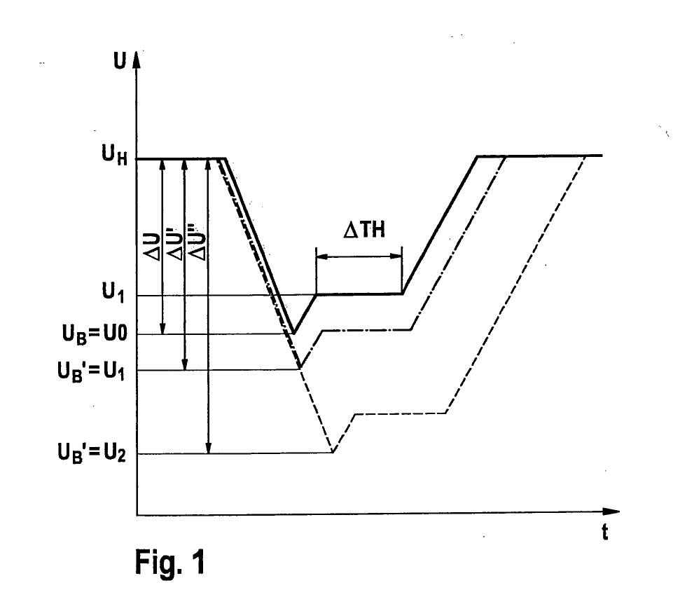

FIG. 1 the voltage characteristic at the piezoelectric actuator over the time;

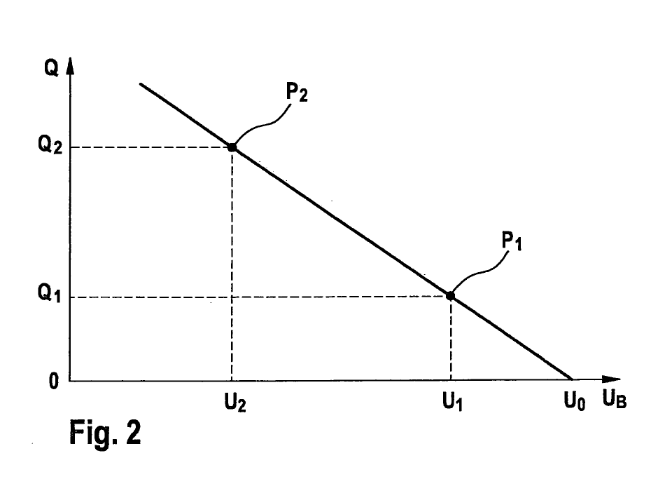

FIG. 2 a diagram of the injection quantity over the bottom voltage;

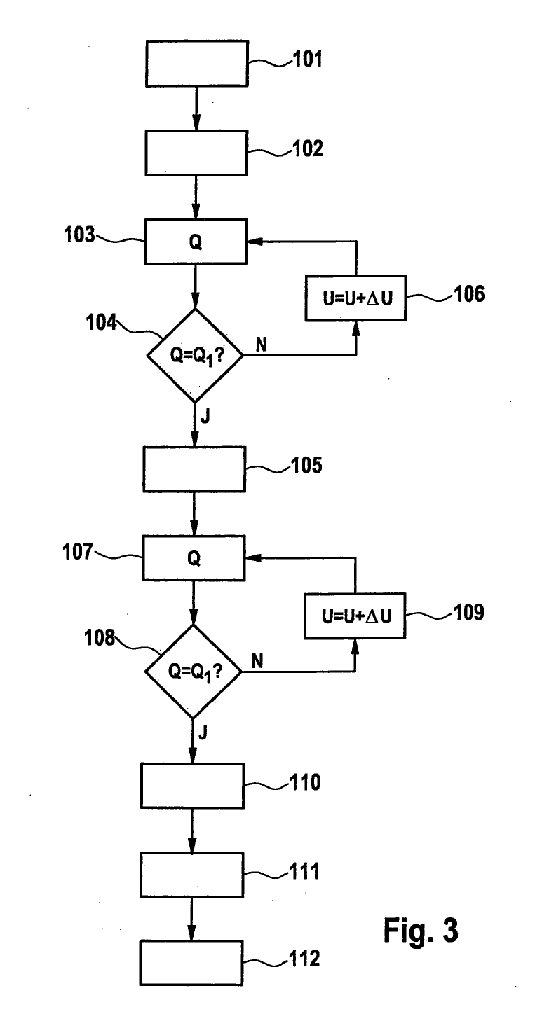

FIG. 3 a flow chart of an exemplary embodiment of a method according to the present invention.

### SPECIFIC EMBODIMENT OF THE INVENTION

For the following exemplary embodiments an injector (fuel injector) is assumed, which has a piezoelectric actuator as controller. Such an injector is provided with a piezoelectric actuator, which is triggered by a control device. The piezoelectric actuator is connected to a valve needle via a hydraulic coupler element; the valve needle is able to sit on a valve seat in the interior of the housing of the fuel injector. When the valve needle has lifted off from the valve seat, the fuel injector is open and fuel will be injected. When the valve needle is sitting on the valve seat, then the fuel injector is closed. The transition from the closed to the open state is achieved with the aid of the piezoelectric actuator. To this end, an electric voltage is applied to the actuator, which causes a linear deformation of a piezo stack, which in turn is utilized for opening or closing the fuel injector. A so-called holding voltage is applied to the piezoelectric actor for this purpose, which induces a specific length of the piezo stack. The hydraulic coupling element ensures that the valve needle sits on its valve seat and the fuel injector is closed when a fixed voltage is applied. The hydraulic coupler is unable to compensate sufficiently rapid variations of the voltage applied at the piezo element; a voltage change which causes a shortening of the piezoelectric element thus induces an injection.

FIG. 1 illustrates the voltage characteristic of voltage U at the piezoelectric actuator over time t. In the closed state of the fuel injector, holding voltage U_{H} is applied. To deliver an injection, holding voltage U_{H} is lowered to what is referred to as bottom voltage U_{B}. Bottom voltage U_{B} may be maintained for a suitable period of time, but may also be directly raised to a suitable other voltage that deviates from the holding voltage. At the end of the injection, holding voltage U_{H} is applied to the piezoelectric actuator again. In the exemplary embodiment of FIG. 1, holding voltage U_{H} is first lowered to bottom voltage U_{B} in order to deliver an injection, then raised to an intermediate voltage U₁ and kept constant for a holding period £t_{H}, and then raised again to holding voltage U_{H} with a rising flank. If holding voltage U_{H} is kept constant and the voltage characteristic and holding period Δt_{H} are kept constant as well, then the injection quantity essentially is a function of bottom voltage U_{B}. The difference between holding voltage U_{H} and bottom voltage U_{B} is denoted as voltage range ΔU. That is to say, if only bottom voltage U_{B} is modified, then only voltage range ΔU is varied so that injection quantity P is a function of voltage range ΔU.

A change in injection quantity P of a cylinder affects torque m of the internal combustion engine. In the following illustration it is assumed that the internal combustion engine is in overrun operation.

According to the present invention, the voltage range during a pre-injection of a cylinder in overrun operation of the internal combustion is now reduced until it is ensured that no pre-injection will take place. Reducing the voltage range while the output voltage remains unchanged means an increase in the bottom voltage. This value of bottom voltage U_{B} is denoted as UO in FIG. 1. The voltage range is then increased in a stepwise manner during the pre-injection until a pre-injection takes place. In overrun operation, this is easily measurable by the engine-speed signal of the internal combustion engine; a completed pre-injection supplies an additional torque of the internal combustion engine so that the engine speed increases. Via the engine-speed increase, it is possible to determine the additional gas torque of the cylinder in which the pre-injection was delivered, and thus to determine the injection quantity with the aid of a model of the combustion. The voltage range at the cylinder is then set such that a defined first injection quantity Q₁ is injected, e.g., one cubic millimeter per injection. Associated with the defined first injection quantity is a voltage range and thus a bottom voltage, which are denoted by U′ and U_{B}′ in FIG. 1. One obtains a first value pair U₁/Q₁. In a next step, bottom voltage U_{B} and thus voltage range ΔU is modified until a defined second injection quantity Q₂ of, for example, three cubic millimeters per injection is achieved. This value is denoted as voltage range ΔU″ or as bottom voltage U_{B}′ in FIG. 1. All other values, in particular holding voltage U_{H} and holding period Δt_{H}, remain unchanged. The presence of second defined injection quantity Q2 of, in this case, three cubic millimeters per injection, for example, is in turn determined with the aid of the engine-speed signal. In this way, a second value pair U₂/Q₂ is obtained.

For the further determination of a characteristics map of the correlation of the voltage range or, with a constant holding voltage, bottom voltage U_{B}, to injection quantity Q, a linear correlation between the two is assumed. Using the previously determined two value pairs of bottom voltage/injection quantity, it is now possible to determine a straight line with whose aid the additional value pairs of the characteristics map are ascertained. This relationship is illustrated in FIG. 2. A first point P₁ with a value pair U₁/Q₁, and a second point P₂ value pair U₂/Q₂ is determined as previously illustrated. An offset line is placed through both, all value pairs of bottom voltage/injection quantity or voltage range/injection quantity lying on this straight line. If appropriate, more than two points may be utilized to determine the straight extrapolation or interpolation line according to FIG. 2; in this case, a suitable adaptation method must be selected, such as, for example, a least square method or the like in order to place the offset line through the sets of points.

FIG. 3 shows a flow chart of an exemplary embodiment of a method according to the present invention. The method begins in step 101 with the internal combustion engine transitioning to overrun operation. In step 102, the bottom voltage for the pre-injection is reduced in one cylinder to a value (e.g., a fixedly specified value for the particular injector type) at which no injection is delivered. Then the bottom voltage is increased in a loop until a defined injection quantity, such as 1 mm³, for example, is injected. On the basis of the engine speed characteristic, the torque contributed by the pre-injection is determined in step 103 and, on the basis of the torque, the injection quantity. In step 104, it is checked whether required injection quantity Q₁ has been reached. If this is the case (option J), then the associated bottom voltage U₁ together with injection quantity Q₁ is stored as value pair U₁/Q₁ in step 105; otherwise (option N), the bottom voltage is increased by a voltage amount ΔU in step 106. If value pair U₁/Q₁ is determined in the loop of steps 103 through 106, then a similar loop of steps 107 through 110 will follow in order to determine value pair U₂/Q₂, injection quantity Q being determined in step 107, a check taking place in step 108 as to whether the injection quantity has reached value Q₂, the bottom voltage being increased in a loop in step 109, and value pair U₂/Q₂ being stored in step 110. In step 111, a linear equation is set up using both value pairs U₁/Q₁ and U₂/Q₂, with whose aid a characteristics map is determined in step 112 and stored in a control device.

1-10. (canceled)

11. A method for determining a characteristics map of an injection quantity via an electric variable of an electrically triggered injector, comprising:
varying the electric variable during operation of the internal combustion engine, from an initial value at which no injection is delivered, until a defined first injection quantity is injected; and
assigning a value set at the defined first injection quantity to the defined first injection quantity as first value of the electric variable.

12. The method as recited in claim 11, further comprising:
modifying the electric variable so that a defined second injection quantity is injected, a value set at the defined second injection quantity being assigned to the defined second injection quantity as a second value of the electric variable.

13. The method as recited in claim 12, further comprising:
determining a characteristics map of electric value to injection quantity using an extrapolation and interpolation function from a value pair of the first injection quantity and the first electrical value and a value pair of the second injection quantity and the second electric value.

14. The method as recited in claim 13, wherein additional value pairs are included in the extrapolation or interpolation.

15. The method as recited in claim 13, wherein the extrapolation and interpolation function is a linear function.

16. The method as recited in claim 11, wherein the electrically triggered fuel injector is triggered piezoelectrically, and the electric variable is a voltage range between a holding voltage and a bottom voltage.

17. The method as recited in claim 11, wherein the injection quantity is determined based on a time characteristic of a torque of a crankshaft of the internal combustion engine.

18. The method as recited in claim 17, wherein the injection quantity is determined using an overrun gas torque model of a cylinder of the internal combustion engine, from the time characteristic of the torque of the crankshaft of the internal combustion engine.

19. A control device for an internal combustion engine, which is adapted to determine a characteristics map of an injection quantity via an electric variable of an electrically triggered injector, the control device adapted to vary the electric variable during operation of the internal combustion engine, from an initial value at which no injection is delivered, until a defined first injection quantity is injected, a value set at the defined first injection quantity being assigned to the defined first injection quantity as first value of the electric variable.

20. A memory medium storing a computer program, the computer program, when executed by a computer, causing the computer to determine a characteristics map of an injection quantity via an electric variable of an electrically triggered fuel injector, the computer varying the electric variable during operation of the internal combustion engine, from an initial value, at which no injection is delivered until a defined first injection quantity is injected, a value set at the defined first injection quantity being assigned to the defined first injection quantity as a first value of the electric variable.
